(19) United States
(12) Patent Application Publication
(10) Pub. No.: US 2024/0257261 A1
(43) Pub. Date: Aug. 1, 2024

(54) SYSTEMS AND METHODS FOR PRESCRIPTION PRICE COMPARISON ACROSS PROCESSORS

(71) Applicant: OPTUM, INC., Minnetonka, MN (US)

(72) Inventors: Holly Calahan, Fort Worth, TX (US); Jason Grantham, Dallas, TX (US)

(21) Appl. No.: 18/162,296

(22) Filed: Jan. 31, 2023

(51) Int. Cl. G06Q 40/08

(52) U.S. Cl. CPC G06Q 40/08

(57) ABSTRACT

A pharmacy claims switch is provided that allows pharmacy claims processors to determine the lowest cost for a prescription. A pharmacy submits a claim to the switch. The claim may be for a prescription for a patient and may identify a processor associated with the patient. The switch submits the claim to a third-party intermediary who submits the claim to the identified processor. The identified processor provides a response with a price for the patient. The third-party intermediary instructs the switch to submit follower claims to alternative processors. The switch receives responses from each alternative processor that includes a price the pharmacy should charge. Based on the prices in each response, the third-party intermediary selects the processor with the lowest price, and sends a response to the switch that identifies the selected processor. The pharmacy claims switch updates the pharmacy, which may present the best price to the patient.

### BACKGROUND

Pharmacy Benefit Managers (PBMs), Pharmacy Claim Processors, and Health Plans struggle obtaining the most affordable out of pocket price for patients in an efficient and automated manner at point-of-sale. The operating space each of the target customers works in daily limits his/her ability to execute complex pharmacy claim rerouting scenarios in a real-time environment. Current workflows involve manual processes to be completed by retail pharmacy networks to gather a patient best price, which may be either a PBM price or the best market discount price.

A current solution to this problem is a manual process relying on retail pharmacy networks or the patient to gather information to identify the lowest out-of-pocket price. As a result, the pharmacist may try a manual process that includes submitting the prescription information to a prescription drug plan processor, evaluating the response that is returned, reversing the submission, and then repeating these steps for various copay discount cards in search of the lowest out-of-pocket price. With each submission and reversal, the pharmacy incurs switch and potential processor transaction fees, as well as lost productivity of the pharmacy staff.

### SUMMARY

In an embodiment, a pharmacy claims switch is provided that automatically halts or suspends an existing claim processing workflow in order to enable a third-party intermediary to assist in determining the lowest cost for a prescription for a patient in a way that is seamless to the pharmacy and the patient. Initially, a pharmacy submits a claim request to the pharmacy claims switch. The claim request may be for a prescription being filled by the pharmacy for the patient and may identify a claims processor associated with the patient such as an insurance payor. The switch halts the claim request 105 and reroutes the claim request to a third-party intermediary, such as a pharmacy claims processor, pharmacy benefits manager or payer, who submits the claim request to the identified claims processor. The identified claims processor provides a response to the claim request that includes a price that the pharmacy should charge the patient. Upon receiving the response, rather than providing the response to the prescription claim switch for communicating to the pharmacy, the third-party intermediary may instruct the pharmacy claims switch to suspend the current claim request/request transaction and submit the claim to one or more alternative claims processors. The pharmacy claims switch receives responses from each alternative claims processor, each indicating what the pharmacy should charge the patient, and provides those responses to the third-party intermediary. Based on the prices in each response, the third-party intermediary selects the processor with the lowest price and sends to the pharmacy claims switch a response to the original claim request, reinstating the original claim request/response transaction, that identifies the selected processor and lowest price. The pharmacy claims switch may then update the pharmacy, which may present the best price to the patient.

In an embodiment, a method is provided. The method includes: receiving a claim from a pharmacy by a computing device, wherein the claim identifies a claims processor and is associated with a patient; based on the identified claims processor, providing the claim to a third-party intermediary by the computing device; receiving, by the computing device from the third-party intermediary, an instruction to provide the claim to one or more alternative claims processors; for each of the one or more alternative claim processors, sending the claim to the alternative claims processor by the computing device; for each of the one or more alternative claims processors, receiving a response to the claim from the alternative claims processor by the computing device; providing each received response to the third-party intermediary by the computing device; receiving a response to the claim from the third-party intermediary by the computing device; and providing, by the computing device, the response from the third-party intermediary to the pharmacy, wherein the response from the third-party intermediary indicates one of the identified claims processor or the one or more alternative claims processors that will process the claim.

The systems and methods described herein provide numerous advantages over the prior art. First, because the hardware switch automatically facilitates the collection of multiple prices from processors in response to a single claim submission without input or action from the pharmacist, the time spent by pharmacists and patients is greatly reduced when compared with previous methods for price comparison. Second, because prices are collected from multiple alternative claims processors and an identified claims processor for a claim, the likelihood that the patient receives the best possible price for their prescription is greatly increased.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated herein and form part of the specification, illustrate a system and method for comparing prescription prices across processors. Together with the description, the figures further serve to explain the principles of system and method for comparing prescription prices across processors described herein and thereby enable a person skilled in the pertinent art to make and use the system and method for comparing prescription prices across processors.

FIG. 1 is an example environment for pricing prescriptions and comparing prescription prices across multiple processors;

FIG. 2 is an illustration of a method for automatically suspending prescription claim processing to allow for optimal price discovery; and

FIG. 3 shows an example computing environment in which example embodiments and aspects may be implemented.

### DETAILED DESCRIPTION

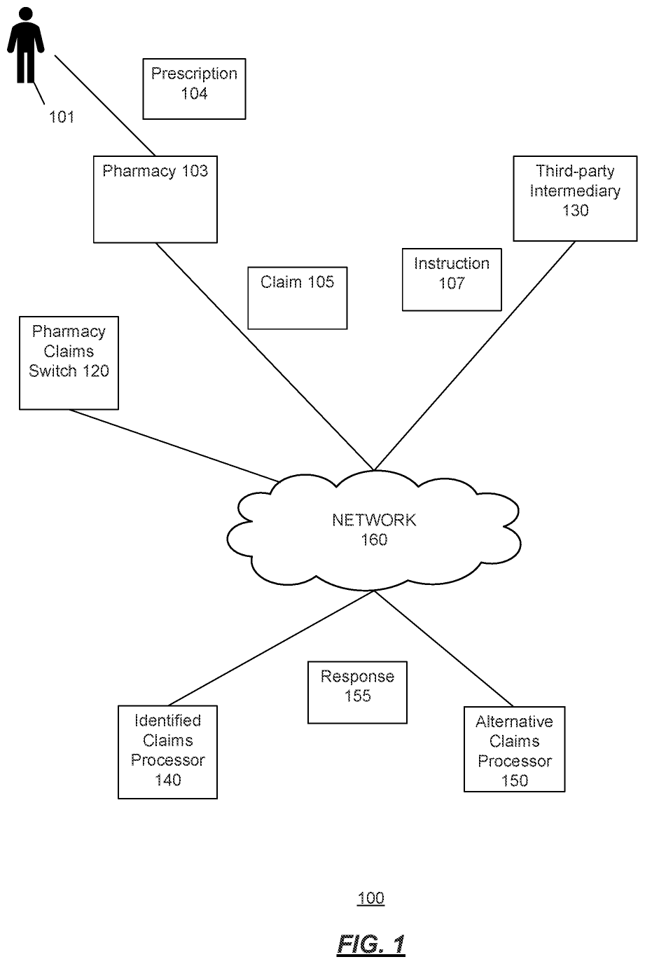

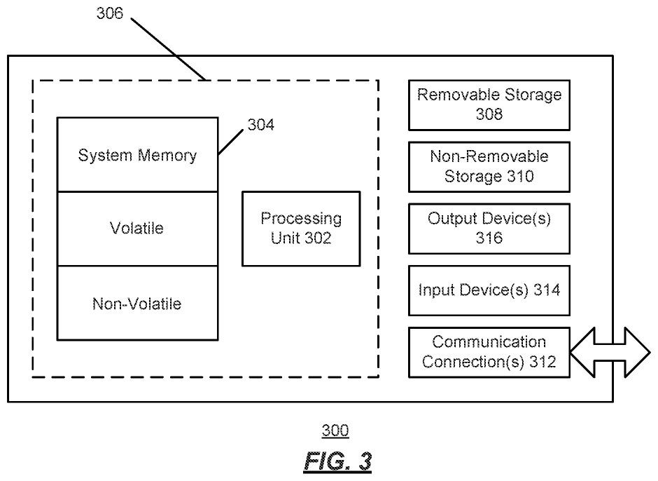

FIG. 1 is an example environment 100 for pricing prescriptions across multiple processors. As shown, the environment 100 may include one or more pharmacies 103, one or more pharmacy claims switches 120, one or more third-party intermediaries 130, one or more identified claims processors 140, and one or more alternative claims processors 150 in communication through a network 160. The network 160 may include a combination of private networks (e.g., LANs) and public networks (e.g., the Internet). Each of the one or more pharmacies 103, one or more pharmacy claims switches 120, one or more third-party intermediaries 130, one or more identified claims processors 140, and one or more alternative claims processors 150 may use, or may be partially implemented by, one or more general purpose computing devices such as the computing device 300 illustrated in FIG. 3.

A patient 101 may provide a prescription 104 to a pharmacy 103 for fulfillment. The prescription 104 may be for a particular medication. As part of the fulfilment process, the pharmacy 103 may determine the cost (if any) that the patient 101 should pay for the medication.

As described above, previously, in order to determine the lowest cost for a prescription, a pharmacist, or staff member, at a pharmacy 103 would first submit a claim 105 for a prescription 104 to a pharmacy claims processor associated with an insurance provider of the patient 101, receive the cost. Reverse the submission, and then repeat for one or more discount or alternative claims processors 150. As may be appreciated, this was an arduous and time consuming task for both the pharmacist and the patient 101.

Accordingly, in order to determine the lowest cost to the patient 101 for a prescription 104 using a single claim 105 submission from a pharmacy 103, the environment 100 may include the pharmacy claims switch 120. In the example shown, the pharmacy 103 may generate and provide a claim 105 to the pharmacy claims switch 120. The claim 105 may identify the patient 101 and may identify a claims processor 140 associated with the patient 101. The identified claims processor 140 may be an insurance company or insurance payor of which the patient 101 is a member or with which the patient 101 has an account. Alternatively, the identified claims processor 140 may be an entity working on behalf of an insurance company or an insurance payor.

In some embodiments, the claim 105 may be a NCPDP telecommunication standard billing transaction. Other types of transactions or formats may be supported. The claim 105 may identify the patient 101 and may include a Bank Identification Number (BIN) and/or a Processor Control Number (PCN) of the identified claims processor 140. Other information may be included in the claim 105. The initial claim 105 with the original BIN and/or PCN of the identified claims processor 140 is referred to herein as the leader claim 105.

The pharmacy claims switch 120 may receive the leader claim 105, and may, rather than forward it to the identified claims processor 140, instead forward it to a third-party intermediary 130 based on the BIN and/or the PCN associated with the leader claim 105. The third-party intermediary 130 may be a pharmacy claims processor, pharmacy benefits manager, or payer, that contracts with the pharmacy claims switch 120 to allow for the comparison of prescription costs for the patient 101 from among the identified claims processors 140 and the alternative claims processors 150. As used herein an alternative claims processor 150 is an entity other than an identified claims processor 140 that also processes prescription claims for patients 101.

After submission of the leader claim 105 to the third-party intermediary 130, the leader claim 105 may be considered to be suspended by the pharmacy claims switch 120. As will be described further below, the leader claim 105 may remain suspended until one or more responses 155 are received from the identified claims processor 140 and one or more alternative claims processor(s) 150. Depending on the embodiment, if a timeout error is received, the pharmacy claims switch 120 may resubmit the leader claim 105 to the third-party intermediary 130.

The third-party intermediary 130 may receive the leader claim 105 from the pharmacy claims switch 120, and may send the leader claim 105 to the identified claims processor 140. The identified claims processor 140 may then generate a response 155 that indicates the price or cost that the patient 101 should be charged for the prescription 104 by the pharmacy 103. The cost may include any co-pay or other fees that should be paid by the patient 101 to the pharmacy 103. The identified claims processor 140 may provide the response 155 including the cost to the third-party intermediary 130. The response 155 may be a NCPDP telecommunication standard billing response. Other formats may be used.

The third-party intermediary 130 may receive the response 155 from the identified claims processor 140 and may determine to also price the leader claim 105 from one or more of the alternative claims processors 150. In some embodiments, the third-party intermediary 130 may select one or more alternative claims processors 150 to price the leader claim 105. The selected alternative claims processors 150 may be preselected for the third-party intermediary 130.

The third-party intermediary 130 may generate an instruction 107 for the pharmacy claims switch 120 to price the leader claim 105 with the selected one or more alternative claims processors 150, thereby suspending the original leader claim 105/response transaction until an optimal price is determined. In some embodiments, the third-party intermediary 130 may generate, for each selected alternative claims processor 150, a version of the leader claim 105. Each version of the leader claim 105 for an alternative claims processor 150 may be substantially similar to the leader claim 105 but may replace the BIN and/or PCN of the identified claims processor 140 in the leader claim 105 with the BIN and/or PCN of the alternative claims processor 150. Each of these claims 105 with BIN and/or PCN of an alternative claims processor 150 is referred to herein as a follower claim 105. The follower claims 105 may be provided to the pharmacy claims switch 120 as the instruction 107.

The pharmacy claims switch 120, upon receiving the instruction 107, may send each of the follower claims 105 to a corresponding alternative claims processor 150 based on the BIN and/or PCN in each follower claim 105. Some or all of the alternative processors 150 may return a response 155 to the pharmacy claims switch 120 that includes a price or cost for the prescription 104 for the patient 101 charged by the alternative claims processor 150.

The pharmacy claims switch 120 may pass on each response 155 received from the alternative claims processor 150 to the third-party intermediary 130. The third-party intermediary 130 may then select a response 155 from among the responses 155 received from the alternative claims processors 150 and the response 155 received from the identified claims processor 140.

In some embodiments, the third-party intermediary 130 may select the response 155 with the lowest price or overall cost to the patient 101. The third-party intermediary 130 may send the selected response 155 to the pharmacy claims switch 120 as a final response to the original leader claim 105, thereby resuming the initial leader claim 105/response transaction.

The pharmacy claims switch 120 may receive the response 155 and may send the response 155 to the pharmacy 103. The pharmacy 103 may then charge the patient 101 according to the cost or price indicated in the response 155.

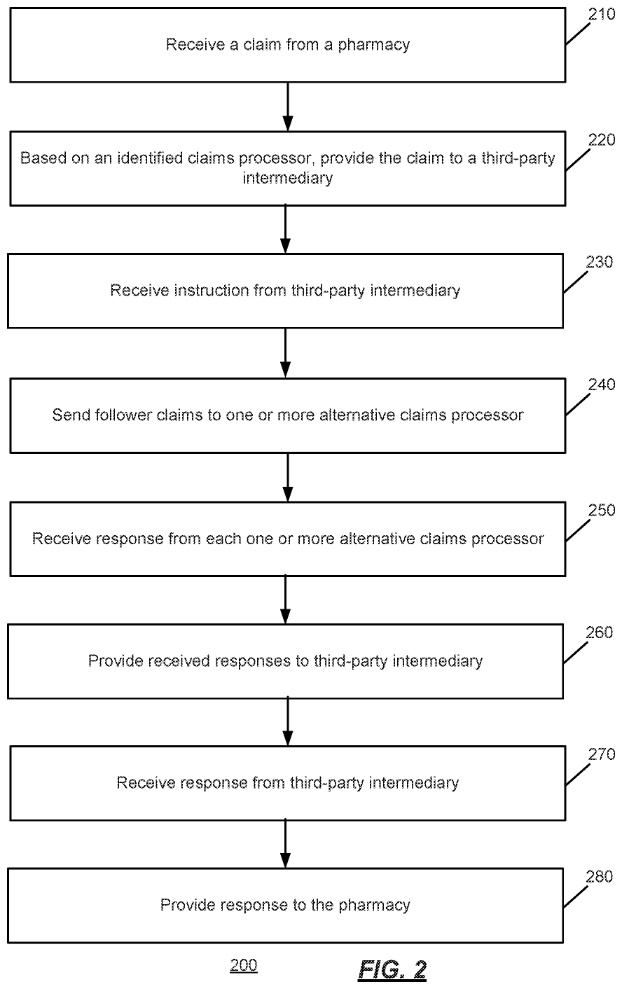

FIG. 2 is an illustration of an example method 200 for automatically suspending prescription claim processing to allow for optimal price discovery. The method 200 may be implemented by the pharmacy claims switch 120.

At 210, a claim is received from a pharmacy. The claim 105 may be for a medication for a patient 101. The claim 105 may be the leader claim 105 and may be received by a pharmacy claims switch 120 from the pharmacy 103 through a network 160 such as the internet. The claim 105 may include a BIN and/or a PCN that identifies an identified claims processor 140 for the claim 105. The identified claims processor 140 may be an insurance company, for example.

At 220, the claim 105 is provided to a third-party intermediary. The third-party intermediary 130 may be an entity associated with the pharmacy claims switch 120 that is configured to query and discover optimal prescription claim pricing. Depending on the embodiment, the third-party intermediary 130 may be a pharmacy claims processor, pharmacy benefits manager, third-party vendor, or payer. The third-party intermediary 130 may in turn provide the claim 105 to an identified claims processor 140 associated with the claim 105.

At 230, an instruction is received from the third-party intermediary. The instruction 107 may be received by the pharmacy claims switch 120 from the third-party intermediary 130. In some embodiments, the instruction 107 may be an instruction for the pharmacy claims switch 120 to suspend the leader claim 105/response transaction and send the claim 105 to one or more alternative claims processors 150. In some embodiments, the instruction 107 may be or may include a plurality of follower claims 105. Each follower claim 105 may be similar to the leader claim 105 received by the pharmacy claims switch 120 but with the BIN and/or PSN of the identified claims processor 140 replaced by the BIN and/or PNS of an alternative claims processor 150.

At 240, follower claims are sent to each of the one or more alternative claims processor 150. In some embodiments, the pharmacy claims switch 120 may generate each follower claim 105 by replacing the BIN and/or PCN of the leader claim 105 with the BIN and/or PCN of an alternative claims processor 150, and may send each generated follower claim 105 to a corresponding alternative claims processor 150. In other embodiments, the pharmacy claims switch 120 may receive the follower claims 105 from the third-party intermediary 130 as the instruction 107, and may send each follower claim 105 to a corresponding alternative claims processor 150.

At 250, responses from the one or more alternative claims processors are received. The responses 155 may be received by the pharmacy claims switch 120. Each response 155 may include a price or a cost for the patient 101 with respect to the prescription 104.

At 260, the received responses are provided to the third-party intermediary 130. The responses 155 may be provided by the pharmacy claims switch 120.

At 270, a response to the original leader claim 105 is received from the third-party intermediary. The response 155 may be received by the pharmacy claims switch 120 and may resume/conclude the suspended leader claim 105/response transaction. The response 155 may be either the original response 155 received from the identified claims processor 140, or one of the responses 155 received from the one or more alterative claims processors 150. In some embodiments, the response 155 may be the response 155 with lowest cost or price for the patient 101.

At 280, the response is provided to the pharmacy. The response 155 may be provided to the pharmacy 103 by the pharmacy claims switch 120. The pharmacy 103 may then charge the patient 101 the cost or price indicated in the response 155 for the prescription 104.

FIG. 3 shows an example computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 3, an example system for implementing aspects described herein includes a computing device, such as computing device 300. In its most basic configuration, computing device 300 typically includes at least one processing unit 302 and memory 304. Depending on the exact configuration and type of computing device, memory 304 may be volatile (such as random access memory (RAM)), non-volatile (such as read-only memory (ROM), flash memory, etc.), or some combination of the two. This most basic configuration is illustrated in FIG. 3 by dashed line 306.

Computing device 300 may have additional features/functionality. For example, computing device 300 may include additional storage (removable and/or non-removable) including, but not limited to, magnetic or optical disks or tape. Such additional storage is illustrated in FIG. 3 by removable storage 308 and non-removable storage 310.

Computing device 300 typically includes a variety of computer readable media. Computer readable media can be any available media that can be accessed by the device 300 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 304, removable storage 308, and non-removable storage 310 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 300. Any such computer storage media may be part of computing device 300.

Computing device 300 may contain communication connection(s) 312 that allow the device to communicate with other devices. Computing device 300 may also have input device(s) 314 such as a keyboard, mouse, pen, voice input device, touch input device, etc. Output device(s) 316 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although example implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving a claim from a pharmacy by a computing device, wherein the claim identifies a claims processor and is associated with a patient;
based on the identified claims processor, providing the claim to a third-party intermediary by the computing device;
receiving, by the computing device from the third-party intermediary, an instruction to provide the claim to one or more alternative claims processors;
for each of the one or more alternative claim processors, sending the claim to the alternative claims processor by the computing device;
for each of the one or more alternative claims processors, receiving a response to the claim from the alternative claims processor by the computing device;
providing each received response to the third-party intermediary by the computing device;
receiving a response to the claim from the third-party intermediary by the computing device; and
providing, by the computing device, the response from the third-party intermediary to the pharmacy, wherein the response from the third-party intermediary indicates one of the identified claims processor or the one or more alternative claims processors that will process the claim.

2. The method of claim 1, wherein the response from the third-party intermediary further indicates a price that the patient should pay the pharmacy for a prescription identified by the claim.

3. The method of claim 1, wherein the third-party intermediary is a pharmacy claims processor or a pharmacy benefits manager.

4. The method of claim 1, wherein the identified claims processor is an insurance payor.

5. The method of claim 1, wherein the one or more alternative claims processors are selected by the third-party intermediary.

6. The method of claim 1, wherein the claim includes an identifier of an insurance payor and further comprising selecting the third-party intermediary from a plurality of third-party intermediaries based on the identifier.

7. The method of claim 6, wherein the identifier is one or more of a BIN or a PCN.

8. The method of claim 1, wherein the instruction to provide the claim to one or more alternative claims processors comprises a plurality of follower claims, wherein each follower claim is associated with one of the one or more alternative claims processors; and
wherein, for each of the one or more alternative claim processors, sending the claim to the alternative claims processor comprises sending each of the plurality of the follower claims to an associated alternative claims processor.

9. A pharmacy claims switch comprising:
at least one processor; and
a computer-readable medium storing instructions that when executed by the at least one processor cause the at least one processor to:
receive a claim from a pharmacy, wherein the claim identifies a claims processor and is associated with a patient;
based on the identified claims processor, provide the claim to a third-party intermediary;
receive from the third-party intermediary an instruction to provide the claim to one or more alternative claims processors;
for each of the one or more alternative claim processors, send the claim to the alternative claims processor;
for each of the one or more alternative claims processors, receive a response to the claim from the alternative claims processor;
provide each received response to the third-party intermediary;
receive a response to the claim from the third-party intermediary; and
provide the response from the third-party intermediary to the pharmacy, wherein the response from the third-party intermediary indicates one of the identified claims processor or the one or more alternative claims processors that will process the claim.

10. The pharmacy claims switch of claim 9, wherein the response from the third-party intermediary further indicates a price that the patient should pay the pharmacy for a prescription identified by the claim.

11. The pharmacy claims switch of claim 9, wherein the third-party intermediary is pharmacy claims processor or a pharmacy benefits manager.

12. The pharmacy claims switch of claim 9, wherein the identified claims processor is an insurance payor.

13. The pharmacy claims switch of claim 9, wherein the one or more alternative claims processors are selected by the third-party intermediary.

14. The pharmacy claims switch of claim 9, wherein the claim includes an identifier of an insurance payor and further comprising selecting the third-party intermediary from a plurality of third-party intermediaries based on the identifier.

15. The pharmacy claims switch of claim 14, wherein the identifier is one or more of a BIN or a PCN.

16. The pharmacy claims switch of claim 9, wherein the instruction to provide the claim to one or more alternative claims processors comprises a plurality of follower claims, wherein each follow claim is associated with one of the one or more alternative claims processors; and
wherein, for each of the one or more alternative claim processors, sending the claim to the alternative claims processor comprises sending each of the plurality of follower claims to an associated alternative claims processor.

17. A non-transitory computer-readable medium storing instructions that when executed by the at least one processor cause the at least one processor to:
receive a claim from a pharmacy, wherein the claim identifies a claims processor and is associated with a patient;
based on the identified claims processor, provide the claim to a third-party intermediary;
receive from the third-party intermediary an instruction to provide the claim to one or more alternative claims processors;
for each of the one or more alternative claim processors, send the claim to the alternative claims processor;
for each of the one or more alternative claims processors, receive a response to the claim from the alternative claims processor;
provide each received response to the third-party intermediary;
receive a response to the claim from the third-party intermediary; and
provide the response from the third-party intermediary to the pharmacy, wherein the response from the third-party intermediary indicates one of the identified claims processor or the one or more alternative claims processors that will process the claim.

18. The computer-readable medium of claim 17, wherein the response from the third-party intermediary further indicates a price that the patient should pay the pharmacy for a prescription identified by the claim.

19. The computer-readable medium of claim 17, wherein the third-party intermediary is pharmacy claims processor or a pharmacy benefits manager.

20. The computer-readable medium of claim 19, wherein the identified claims processor is an insurance payor.
